(19) United States
(12) Patent Application Publication
(10) Pub. No.: US 2026/0173192 A1
(43) Pub. Date: Jun. 18, 2026

(54) METHOD OF UNICAST SIDELINK COMMUNICATION AND DEVICE THEREOF

(71) Applicant: SAMSUNG ELECTRONICS CO., LTD., SUWON-SI (KR)

(72) Inventor: Ouming Liu, Suzhou Industrial Park (CN)

(21) Appl. No.: 19/017,906

(22) Filed: Jan. 13, 2025

(30) Foreign Application Priority Data
Dec. 16, 2024 (CN) 202411854433.3

(51) Int. Cl. H04W 76/18; H04W 92/18

(52) U.S. Cl. CPC H04W 76/18; H04W 92/18

(57) ABSTRACT

The present disclosure provides a method of unicast sidelink communication and a device thereof. A method of unicast sidelink communication, performed by a first user equipment (UE), includes: transmitting a reconfiguration message to a second UE; receiving a reconfiguration failure message including a reason for a reconfiguration failure, transmitted by the second UE in response to the reconfiguration failure; updating the reconfiguration message based on the reason for the reconfiguration failure; and transmitting the updated reconfiguration message to the second UE.

### CROSS REFERENCE TO RELATED APPLICATION

This application is related to and claims priority to China Patent Application No. 202411854433.3, filed in the China National Intellectual Property Administration on Dec. 16, 2024, the entire content of which is incorporated by reference herein.

### TECHNICAL FIELD

The present disclosure relates generally to the field of wireless communication technology, and more particularly to a method of unicast sidelink communication and a device thereof.

### DISCUSSION OF RELATED ART

Unicast sidelink communication may be understood as direct communication between a first user equipment (UE) and a second UE (one-to-one communication) based on the new radio (NR) PC5 interface. Unicast sidelink communication may also be used for vehicle to everything (V2X) communication, allowing for direct communication between vehicles. UEs that have been authorized to be used for special communication may employ unicast sidelink communication. Unicast sidelink communication may provide information interaction not only within the network coverage service area, but also in regions without network coverage.

To provide more reliable communication services with shorter delay and higher data rate on unicast sidelink, improvements in communication performance of the terminal in various special scenarios may be required. Currently, if a transmitting UE receives a radio resource control reconfiguration failure sidelink (RRCReconfigurationFailureSidelink) message from the peer UE during a link establishment process, the sidelink service cannot be carried out normally, which reduces the security and reliability of communication.

### SUMMARY

Embodiments of the present disclosure relate to a method of unicast sidelink communication and a device thereof that may solve some or all of the above problems.

According to an aspect of the disclosure, a method of unicast sidelink communication, performed by a first user equipment (UE), includes: transmitting a reconfiguration message to a second UE; receiving a reconfiguration failure message indicative of a reconfiguration failure related to the reconfiguration message, transmitted by the second UE in response to the reconfiguration failure and including a reason for the reconfiguration failure; updating the reconfiguration message based on the reason for the reconfiguration failure; and transmitting the updated reconfiguration message to the second UE.

In various embodiments:

The reason for the reconfiguration failure may be indicated by an extended field included in the reconfiguration failure message. The extended field may be set by the second UE using the received reconfiguration message according to whether a radio link control (RLC) mode conflict for the same logical channel occurs.

The updating of the reconfiguration message based on the reason for the reconfiguration failure may include: reallocating a logical channel identifier based on determining that the reason for the reconfiguration failure is the RLC mode conflict, and updating the reconfiguration message according to the reallocated logical channel identifier; or updating the reconfiguration message according to a default sidelink radio bearer (SLRB) resource, based on determining that the reason for the reconfiguration failure is that at least one other SLRB parameter is not applicable.

The method may further include: checking, after receiving the reconfiguration failure message, whether optimization processing for the reconfiguration failure is initiated via an upper layer configuration; and determining, in the case that the optimization processing for the reconfiguration failure is initiated, whether the reason for the reconfiguration failure is the RLC mode conflict.

The reallocating of the logical channel identifier may include: releasing an original logical channel identifier and related context, and reallocating a logical channel identifier that is different from the original logical channel identifier.

The reallocating of the logical channel identifier that is different from the original logical channel identifier may include: reallocating an unused logical channel identifier, or reallocating, in a case of a previously successful logical channel identifier when reconfiguring the first UE by the second UE, the successful logical channel identifier.

The updating of the reconfiguration message according to the default SLRB resource may include: acquiring the default SLRB resource in different messages according to the current state of the first UE; and updating the reconfiguration message according to the acquired default SLRB resource.

The acquiring of the default SLRB resource in the different messages according to the current state of the first UE includes: releasing context of a current SLRB resource; and acquiring the default SLRB resource in a radio resource control (RRC) reconfiguration message in response to being in an RRC connected state, acquiring the default SLRB resource in a system information block (SIB) 12 in response to being in an RRC idle/inactive state, or acquiring the default SLRB resource in a sidelink pre-configuration information in response to being in an out-of-coverage (OOC) state.

According to another aspect of the disclosure, a method of unicast sidelink communication is provided, which is performed by a second UE, the method including: receiving a reconfiguration message transmitted by a first UE; transmitting to the first UE, in response to a reconfiguration failure related to the reconfiguration message, a reconfiguration failure message including a reason for the reconfiguration failure; and receiving an updated reconfiguration message transmitted by the first UE, wherein the updated reconfiguration message is the reconfiguration message updated by the first UE based on the reason for the reconfiguration failure.

According to a another aspect of the disclosure, a first UE includes: a transmitting circuit configured to transmit a reconfiguration message to a second UE and to transmit an updated reconfiguration message to the second UE; a receiving circuit configured to receive a reconfiguration failure message indicative of a reconfiguration failure related to the reconfiguration message, and including a reason for the reconfiguration failure, transmitted by the second UE in response to the reconfiguration failure; and an updating circuit configured to update the reconfiguration message to generate the updated reconfiguration message, based on the reason for the reconfiguration failure.

According to another aspect of the disclosure, a second UE includes: a receiving circuit configured to receive a reconfiguration message transmitted by a first UE and to receive an updated reconfiguration message transmitted by the first UE; and a transmitting circuit configured to transmit, in response to a reconfiguration failure related to the reconfiguration message, a reconfiguration failure message including a reason for the reconfiguration failure to the first UE, wherein the updated reconfiguration message is the reconfiguration message updated by the first UE based on the reason for the reconfiguration failure.

According to another aspect of the disclosure, a system of unicast sidelink communication is provided, where the system includes the first UE and the second UE with the capabilities as summarized above.

According to another aspect of the disclosure, a computer-readable storage medium is provided with a computer program stored thereon, the program when executed implementing one of the methods of unicast sidelink communication as described above.

Technical solutions provided according to embodiments of the disclosure may result in one or more of the following beneficial effects. First, the reconfiguration failure may be optimally handled according to whether the reason for the reconfiguration failure is the RLC mode conflict. When the reason is the RLC mode conflict, only the logical channel ID is reallocated without adjusting other SLRB parameters. This may adequately ensure the quality of service and may achieve the same communication effect as in a normal situation. In the case that the reason for the sidelink reconfiguration failure is not the RLC mode conflict (e.g., the reason for the reallocation failure is that at least one other SLRB parameter is not applicable), the default SLRB parameter configuration may be adopted, which may ensure the reliability and continuity of the communication in the abnormal situation, despite of the impact on the quality of service to a certain extent. In addition, the manner of selecting the default SLRB resource by the transmitting UE may reduce the conflict of SLRB resources, and the selected default SLRB resource may be more compatible with the capability of the transmitting UE. The method of the unicast sidelink communication and the device thereof according to the present disclosure may provide more reliable quality of service, more robust communication capabilities, and more secure performance.

It should be understood that the above general description and the later detailed description are examples and explanatory only and do not limit the present disclosure.

### BRIEF DESCRIPTION OF THE DRAWINGS

The accompanying drawings herein are incorporated into and form part of the specification, illustrate embodiments consistent with the disclosure, which are used in conjunction with the specification to explain the principles of the disclosure and do not constitute an undue limitation of the disclosure.

FIG. 1 illustrates a flowchart of a successful unicast sidelink reconfiguration.

FIG. 2 illustrates a flowchart of a unicast sidelink reconfiguration failure.

FIG. 3 illustrates an optimization flowchart of a reconfiguration failure for unicast link establishment according to embodiments of the present disclosure.

FIG. 4 illustrates a flowchart of a method of unicast sidelink communication applied to a first UE according to embodiments of the present disclosure.

FIG. 5 illustrates a flowchart of reception of a reconfiguration message according to embodiments of the present disclosure.

FIG. 6 illustrates a flowchart of reception of a reconfiguration failure message according to embodiments of the present disclosure.

FIG. 7 illustrates a flowchart of a reallocation of a logical channel ID according to embodiments of the present disclosure.

FIG. 8 illustrates a flowchart of acquisition of a default SLRB according to embodiments of the present disclosure.

FIG. 9 illustrates a flowchart of a successful reconfiguration for a second UE according to embodiments of the present disclosure.

FIG. 10 illustrates a flowchart of a successful reconfiguration for a first UE according to embodiments of the present disclosure.

FIG. 11 illustrates a flowchart of a method of unicast sidelink communication applied to a second UE according to embodiments of the present disclosure.

FIG. 12 illustrates a block diagram of a first UE according to embodiments of the present disclosure.

FIG. 13 illustrates a block diagram of a second UE according to embodiments of the present disclosure.

FIG. 14 illustrates a system of unicast sidelink communication according to embodiments of the present disclosure.

FIG. 15 illustrates a block diagram of an electronic apparatus according to embodiments of the present disclosure.

### DETAILED DESCRIPTION

To facilitate understanding of the inventive concepts herein and their technical solutions, embodiments of the disclosure will be clearly and completely described below in conjunction with the accompanying drawings.

It should be noted that the terms “first”, “second”, etc. in the specification and claims of the disclosure and the accompanying drawings above are used to distinguish similar objects rather than to describe a particular order or sequence. It should be understood that data so distinguished may be interchanged, where appropriate, so that embodiments of the disclosure described herein may be implemented in an order other than those illustrated or described herein. Embodiments described in the following examples do not represent all embodiments that are consistent with the disclosure. Rather, they are only examples of devices and methods that are consistent with some aspects of the disclosure, as detailed in the appended claims.

It should be noted herein that “at least one of the several items” in this disclosure includes “any one of the several items”, “any combination of the several items” and “all of the several items” the juxtaposition of these three categories. For example, “including at least one of A and B” includes the following three juxtapositions: (1) including A; (2) including B; (3) including A and B. Another example is “performing at least one of operation one and operation two”, which means the following three juxtapositions (1) performing operation one; (2) performing operation two; (3) performing operation one and operation two.

Unicast sidelink communication is direct communication between a user equipment (UE) and a UE based on NR PC5 interface. When the upper layer requests to establish the unicast sidelink (SL) communication and there is data to be transmitted, if the UE is in a radio resource control connected (RRC_CONNECTED) state, a matched sidelink radio bearer (SLRB) resource is selected in the radio resource control reconfiguration (RRCReconfiguration) message, according to quality of service (QOS) parameters provided by the upper layer. If the UE is in an RRC idle/inactive (RRC_IDLE/INACTIVE) state, the matched SLRB resource is selected in a system information block (SIB) 12, according to the QoS parameters. If the UE is in an out-of-coverage (OOC) state, the matched SLRB resource is selected in a sidelink pre-configuration (e.g., SL-PreconfigurationNR) information, according to the QoS parameters.

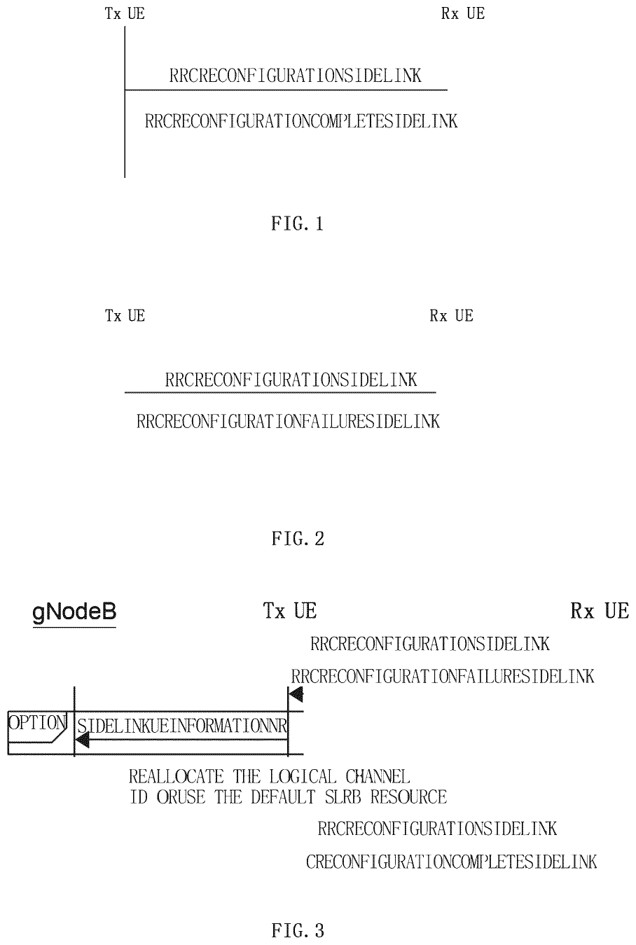

FIG. 1 illustrates a flowchart of a successful unicast sidelink reconfiguration. Referring to FIG. 1, a transmitting (Tx) UE transmits an RRC reconfiguration sidelink (RRCReconfigurationSidelink) message in which SLRB resource information is carried to a receiving (Rx) UE, the receiving UE performs a resource configuration at each layer, and returns an RRC reconfiguration completed sidelink (RRCReconfigurationCompleteSidelink) message to the transmitting UE if the configuration is successful, and the unicast sidelink communication service may be carried out normally.

Some abnormal situations of the unicast sidelink communication that may occur in the UE are as follows: 1) the radio link control (RLC) mode of the receiving UE conflicts with the one carried in the RRCReconfigurationSidelink message, that is, the RLC mode configured by the transmitting UE is different from that configured by the receiving UE for the same logical channel; 2) the SLRB parameter configuration information carried in the RRCReconfigurationSidelink message is not applicable for the receiving UE.

FIG. 2 illustrates a flowchart of a unicast sidelink reconfiguration failure. Referring to FIG. 2, the transmitting UE transmits the RRCReconfigurationSidelink message in which the SLRB resource information is carried to the receiving UE, and the receiving UE fails to reconfigure due to the abnormal situations described above. The receiving UE then returns an RRC reconfiguration failure sidelink (RRCReconfigurationFailureSidelink) message to the transmitting UE.

If the transmitting UE is in the RRC connected state, this problem may be solved by updating the parameter configuration transmitted by the network. The transmitting UE needs to report the error message to the network. This handling method requires multiple instances of interactions through the air interface and a large delay. If the transmitting UE is in the RRC inactive state, the RRC idle state or the OOC scenario, the unicast sidelink communication cannot be carried out for the case of SL RRC reconfiguration during link establishment. If the unicast sidelink data cannot be transmitted and received in a timely manner in high-priority automated driving services, such as emergency obstacle avoidance and highly automated vehicle scheduling, the safety and reliability will be seriously affected.

To solve the above problems, the present disclosure proposes a method of unicast sidelink communication and a device thereof, which are specifically described below with reference to FIGS. 3 to 15 of the accompanying drawings.

FIG. 3 illustrates an optimization flowchart of a reconfiguration failure for unicast link establishment according to embodiments of the present disclosure.

In FIG. 3, entities involved in the optimization flow include a transmitting UE and a receiving UE. The UEs may be any electronic devices with sufficient communication capability to carry out the described operations. Some examples may include: mobile terminals (such as, a smart phone, a cell phone, a video phone, and the like), wearable devices (such as, smart glasses, a head-mounted display (HMD), an e-clothing, an e-bracelet, an e-necklace, an e-accessory, an e-tattoo, or a smart watch, and the like), sensors, mobile medical devices, devices of internet of things, tablets, desktops, laptops, handheld computers, notebook computers, netbooks, personal digital assistants (PDAs), devices in the vehicle to everything (V2X) (such as, a vehicle user equipment (V-UE), a road user equipment (I-UE), a pedestrian user equipment (P-UE) or a network user equipment (N-UE), and the like), augmented /ality/virtual reality apparatuses, etc, and the present disclosure is not limited thereto. The UEs may access the network via the cellular communication networks (e.g., a 4G network, a 5G network, etc.) and other wireless networks (e.g., WLAN, WiFi, etc.) and communicate.

Referring to FIG. 3, the transmitting UE transmits the RRCReconfigurationSidelink message in which the SLRB resource information is carried to the receiving UE. The receiving UE fails to reconfigure due to an abnormal situation, and the receiving UE returns the RRCReconfigurationFailureSidelink message to the transmitting UE.

The transmitting UE may readjust the configuration parameter, which may include reallocating a logical channel identifier (hereinafter also denoted as a logical channel ID or LCID) or using a default SLRB resource. Specifically, the transmitting UE may determine whether the reason for the reconfiguration failure is an RLC mode conflict, and if so, the transmitting UE may reallocate the logical channel ID. In the case that the reason for the reconfiguration failure is not the RLC mode conflict, the transmitting UE may use the default SLRB resource. The transmitting UE transmits the RRCReconfigurationSidelink message in which the adjusted configuration parameter is carried to the receiving UE again. The receiving UE establishes reconfiguration successfully and returns the RRCReconfigurationCompleteSidelink message to the transmitting UE, and the unicast sidelink communication service may be carried out normally.

The entities involved in the above optimization flow may also include a network node, for example, a base station (e.g., gNobeB). After the transmitting UE receives the RRCReconfigurationFailureSidelink message transmitted by the receiving UE, the transmitting UE may, as an optional operation, report UE-related sidelink information (SidelinkUEinformationNR), e.g., the error message being reported to the network.

It should be understood that the above optimization flow of the reconfiguration failure for unicast link establishment is only an example, and the present disclosure is not limited thereto.

Optimization processing for the reconfiguration failure mainly adopted by the method of the unicast sidelink communication of the present disclosure may include the following four operations:

1) The transmitting UE, when receiving the RRCReconfigurationFailureSidelink message, readjusts (e.g., changes) the configuration parameter and transmits the RRCReconfigurationSidelink message again to reconfigure the receiving UE.

2) An extended field of sl-RLC-Mode-Conflict is added to the RRCReconfigurationFailureSidelink message, which is used to indicate whether the reason for the failure is the RLC mode conflict. If the RLC mode of the logical channel indicated by the logical channel ID carried in the RRCReconfigurationSidelink message received by the receiving UE is not consistent with the RLC mode at the local end, the extended field of sl-RLC-Mode-Conflict is set to True, in other cases, it is set to False.

3) The logical channel ID is reallocated (e.g., changed). When the transmitting UE receives the RRCReconfigurationFailureSidelink message and the value of the extended field of sl-RLC-Mode-Conflict in the message is True, it will release the previously allocated logical channel ID and reallocate a logical channel ID different from the previous one.

4) The default SLRB is utilized in certain circumstances. When the transmitting UE receives the RRCReconfigurationFailureSidelink message and the message does not carry the field of sl-RLC-Mode-Conflict or the field of sl-RLC-Mode-Conflict has a value of False. The default SLRB resource is selected and the peer UE is reconfigured.

Points 1)-3) above may be applicable not only to the sidelink reconfiguration flow at the time of link establishment (i.e., establishing the link), but also to the sidelink reconfiguration flows corresponding to all unicast QoS parameter updates.

In the following description, the first UE may be the transmitting UE (Tx UE) and the second UE may be the receiving UE (Rx UE).

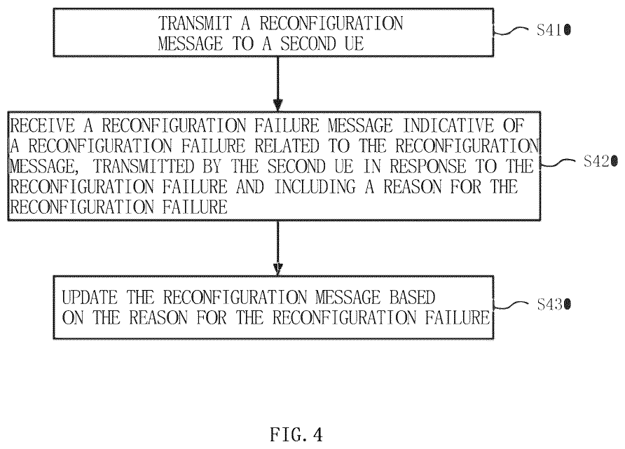

FIG. 4 illustrates a flowchart of a method of unicast sidelink communication applied to a first UE according to embodiments of the present disclosure.

In operation S410, a reconfiguration message is transmitted to a second UE.

In embodiments of the present disclosure, when the upper layer requests to establish the unicast sidelink communication and there is data to be transmitted, the first UE may transmit the RRCReconfigurationSidelink message in which the SLRB resource information is carried to the second UE. The SLRB resource information may include SLRB parameters, examples of which include an SLRB index, a service data adaptation protocol (SDAP) configuration, a packet data convergence protocol (PDCP) configuration, a radio link control (RLC) configuration, and a logical channel configuration of the media access control (MAC), but the present disclosure is not limited thereto. The logical channel configuration of the MAC includes the logical channel ID. The RLC configuration includes the RLC mode. In the unicast sidelink communication, the RLC mode may include an acknowledgement mode (AM) and an unacknowledged mode (UM).

If the first UE receives the RRCReconfigurationCompleteSidelink message returned by the second UE, the unicast sidelink communication is carried out normally. If the first UE receives the RRCReconfigurationFailureSidelink message returned by the second UE, the sidelink reconfiguration failure is indicated.

In operation S420, a reconfiguration failure message, indicative of a reconfiguration failure related to the reconfiguration message, transmitted by the second UE in response to the reconfiguration failure and including a reason for the reconfiguration failure, is received.

According to embodiments of the present disclosure, the reason for the reconfiguration failure may be indicated by an extended field included in the reconfiguration failure message, wherein the extended field may be set by the second UE using the received reconfiguration message according to whether an RLC mode conflict for the same logical channel occurs.

In embodiments of the present disclosure, after the second UE receives the RRCReconfigurationSidelink message transmitted by the first UE, the second UE may use the message and acquire the logical channel ID and RLC mode of the first UE carried in the message. If the acquired logical channel ID of the first UE is LCID4 and the corresponding RLC mode is AM, while the second UE is configured with the RLC mode corresponding to LCID4 being UM, the problem of RLC mode conflict for the same logical channel (identical LCID4) occurs and may result in the reconfiguration failure.

After the second UE receives the RRCReconfigurationSidelink message, although the RLC mode conflict does not occur, at least one other SLRB parameter carried in the message is not applicable for the second UE. For example, the at least one other SLRB parameter for which parameter inapplicability occurs may include the SLRB index and the SDAP header. For example, parameter inapplicable situations may include that the SLRB index carried in the RRCReconfigurationSidelink message is not present in the SLRB resources stored in the second UE, that is, the second UE does not store the SLRB resource which includes this SLRB index. The UE may store a plurality of SLRB resources that may configure itself, and these SLRB resources may be selected by the UE or configured from different information according to different states it is in, for example, if the UE is in the RRC_CONNECTED state, the SLRB resource may be selected from the RRCReconfiguration message and stored. As another example, a parameter inapplicable situation may further include the case that the SLRB index carried in the RRCReconfigurationSidelink message is present in the SLRB resources stored in the second UE, but the SDAP Header configured in the SLRB resource which includes this SLRB index is not consistent with the SDAP Header carried in the RRCReconfigurationSidelink message. The occurrence of inapplicable situations of the at least one other SLRB parameter may also lead to the reconfiguration failure. In the case of the reconfiguration failure, the second UE may return the RRCReconfigurationFailureSidelink message to the first UE. In addition, if the SLRB index carried in the RRCReconfigurationSidelink message is present in the SLRB resources stored in the second UE, but the SLRB resource in the second UE which includes this SLRB index has not been used, then this SLRB resource may possibly not have been configured with an SDAP header. In this case, the second UE may be configured with the SDAP header carried in the RRCReconfigurationSidelink message, and the inapplicable situations of the at least one other SLRB parameter may not occur.

It should be understood that the above logical channel IDs and corresponding modes are only examples and that the inapplicable situations of the at least one other SLRB parameter are also only examples, and the present disclosure is not limited thereto.

In embodiments of the present disclosure, the extended field of sl-RLC-Mode-Conflict is added to the RRCReconfigurationFailureSidelink message, which may be used to indicate whether the reason for the reconfiguration failure is the RLC mode conflict.

FIG. 5 illustrates a flowchart of reception of a reconfiguration message process according to embodiments of the present disclosure.

Referring to FIG. 5, in operation S510, the second UE receives an RRCReconfigurationSidelink message transmitted by the first UE. After receiving the message, in operation S520, the second UE determines whether the reconfiguration is successful. If the reconfiguration is successful, in operation S530, the second UE transmits the RRCReconfigurationCompleteSidelink message to the first UE. If the reconfiguration fails, in operation S540, the second UE determines whether the RLC mode conflict occurs. If the RLC mode conflict occurs, in operation S550, the second UE sets the extended field of sl-RLC-Mode-Conflict in the RRCReconfigurationFailureSidelink message to True, and if the reconfiguration fails due to other situations (i.e., the at least one other SLRB parameter is not applicable), in operation S560, the second UE sets the extended field of sl-RLC-Mode-Conflict in the RRCReconfigurationFailureSidelink message to False. And, in operation S570, the RRCReconfigurationFailureSidelink message is transmitted to the first UE, so that the second UE delivers the detailed failure reason for the sidelink reconfiguration to the first UE.

As described above, the method of the unicast sidelink communication of the present disclosure may add the extended field (e.g., sl-RLC-Mode-Conflict) to the reconfiguration failure message to indicate whether the reason for the reconfiguration failure is the RLC mode conflict, which enables the detailed failure reason for the sidelink reconfiguration to be delivered to the transmitting UE, and facilitates the transmitting UE to optimally deal with the reconfiguration failure.

Returning to FIG. 4, in operation S430, the reconfiguration message is updated based on the reason for the reconfiguration failure.

In operation S440, the updated reconfiguration message is transmitted to the second UE.

According to embodiments of the present disclosure, the method of the unicast sidelink communication may further include: after receiving the reconfiguration failure message, checking whether optimization processing for the reconfiguration failure has been initiated via an upper layer configuration, and determining, in the case that the optimization processing for the reconfiguration failure is initiated, whether the reason for the reconfiguration failure is the RLC mode conflict.

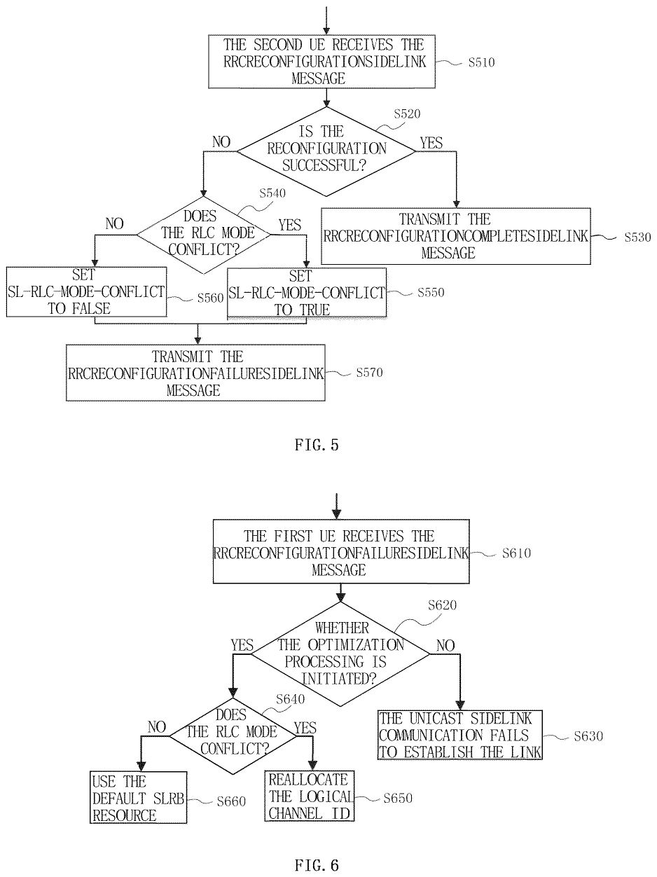

FIG. 6 illustrates a flowchart of reception of a reconfiguration failure message according to embodiments of the present disclosure.

Referring to FIG. 6, in operation S610, the first UE receives the RRCReconfigurationFailureSidelink message transmitted by the second UE. After receiving the message, in operation S620, the second UE checks whether the optimization processing for the reconfiguration failure has been initiated via the upper layer configuration. If the optimization processing for the reconfiguration failure has not been initiated, in operation S630, the unicast sidelink communication fails to establish the link. If the optimization processing for the reconfiguration failure has not been initiated, according to requirements of the 3GPP protocol, the first UE and the second UE may adopt the previously configured resources at this time, and if it is the first time that the sidelink RRC reconfiguration is performed, that is, the reconfiguration is initiated at the time of the unicast link establishment, the previous configuration cannot be used, which will result in the release of the unicast link, the unicast sidelink communication will not be carried out. When the traffic requires high quality of service, such as, emergency trajectory collaboration, collaborative collision avoidance, etc., the optimization processing for the reconfiguration failure may be configured to be initiated, which may improve the reliability and stability of the unicast sidelink communication. If the optimization processing for the reconfiguration failure has been initiated, in operation S640, the first UE determines whether the reason for the reconfiguration failure is the RLC mode conflict. The first UE may use the extended field of sl-RLC-Mode-Conflict carried in the RRCReconfigurationFailureSidelink message to determine whether the reason for the reconfiguration failure is the RLC mode conflict. In the case that the extended field of sl-RLC-Mode-Conflict is True, it is determined that the reason for the reconfiguration failure is the RLC mode conflict, and the first UE may reallocate the logical channel ID in operation S650. In the case that the extended field of sl-RLC-Mode-Conflict is False, it is determined that the reason for the reconfiguration failure is that the at least one other SLRB parameter is not applicable rather than the RLC mode conflict, and in operation S660, the first UE may use the default SLRB resource.

According to embodiments of the present disclosure, a logical channel identifier may be reallocated based on determining that the reason for the reconfiguration failure is the RLC mode conflict, and the reconfiguration message is updated according to the reallocated logical channel identifier.

According to embodiments of the present disclosure, the reallocating of the logical channel identifier may include: releasing an original logical channel identifier and related context, and reallocating a logical channel identifier that is different from the original logical channel identifier.

According to embodiments of the present disclosure, an unused logical channel identifier may be reallocated, or in a case of a previously successful logical channel identifier when reconfiguring the first UE by the second UE, the successful logical channel identifier may be reallocated.

In embodiments of the present disclosure, if the reason for the reconfiguration failure is the RLC mode conflict, this may mean that the RLC mode corresponding to the logical channel ID allocated by the first UE is inconsistent with the RLC mode corresponding to the same logical channel ID of the second UE. Since the RRC layer is responsible for allocating and managing logical channel IDs, it may fully utilize its flexibility to dynamically adjust the allocation strategy of the logical channels according to resource conditions.

FIG. 7 illustrates a flowchart of a reallocation of a logical channel ID according to embodiments of the present disclosure.

Referring to FIG. 7, in operation S710, the first UE may release the original logical channel ID and related context, and in operation S720, the first UE may reallocate a logical channel ID for the current SLRB resource different from the previous logical channel ID. Here, the related context may include: (i) information indicating whether or not the logical channel ID is allocated; and (ii) relevant information of the corresponding SLRB. The relevant information of the corresponding SLRB may include the SLRB index, the RLC mode, and so on. After reallocating the logical channel ID, the first UE also reconfigures the second UE. The first UE may update the RRCReconfigurationSidelink message according to the reallocated logical channel ID. In operation S730, the first UE transmits the updated RRCReconfigurationSidelink message to the first UE. In particular, the first UE may transmit the RRCReconfigurationSidelink message including the reallocated logical channel ID to the second UE.

For example, after the second UE receives the RRCReconfigurationSidelink message transmitted by the first UE, if the logical channel ID of the first UE acquired from the message is LCID4 and the corresponding RLC mode is AM, while the second UE is configured with the RLC mode corresponding to LCID4 being UM, the RLC mode conflict for the same logical channel (identical LCID4) occurs. The second UE may return the RRCReconfigurationFailureSidelink message in which the reason for the reconfiguration failure being the RLC mode conflict is carried to the first UE. Based on the reason for the reconfiguration failure being the RLC mode conflict, the first UE may reallocate the LCID5 with the corresponding RLC mode of AM. Here, the RLC mode corresponding to the reallocated logical channel ID should be consistent with the currently configured RLC mode of the first UE, that is, for the SLRB parameters carried in the RRCReconfigurationSidelink message, the logical channel ID is reallocated without changing the RLC mode. Subsequently, the first UE may transmit the RRCReconfigurationSidelink message including the LCID5 and the corresponding RLC mode (i.e., AM, the RLC mode is unchanged) to the second UE, and the second UE may acquire the LCID5 and the corresponding RLC mode (i.e., AM) of the first UE included in the message and check whether the RLC mode corresponding to LCID5 configured by the second UE is AM. In the case that the RLC mode corresponding to the LCID5 configured by the second UE is AM, the RLC mode conflict may not occur and subsequent reconfiguration may be successful. If the RLC mode conflict occurs again, for example, the RLC mode corresponding to the LCID 5 configured by the second UE is UM, the above operations may be repeated. For example, the second UE may return the RRCReconfigurationFailureSidelink message in which the reason for the reconfiguration failure being the RLC mode conflict is carried to the first UE, and the first UE may reallocate LCID 6 with the corresponding RLC mode of AM and transmit the RRCReconfigurationSidelink message in which the LCID 6 and the corresponding RLC mode (i.e., AM, the RLC mode is unchanged) are carried to the second UE again.

In embodiments of the present disclosure, an unused logical channel ID may become “reallocated” (substituted for a previously allocated logical channel ID). Since the unused logical channel ID means that neither the first UE nor the second UE has yet been configured with the correponding RLC mode, allocating the unused logical channel ID (e.g., LCID7) does not result in the RLC mode conflict. After allocating the unused LCID7, the first UE may transmit the RRCReconfigurationSidelink message in which the LCID7 and the currently configured RLC mode of the first UE (e.g., AM, the RLC mode is unchanged) are carried to the second UE. The second UE may use the LCID7 and configure the corresponding RLC mode to be the RLC mode (e.g., AM) carried in the RRCReconfigurationSidelink message, and accordingly the RLC mode conflict may not occur and subsequent reconfiguration may be successful. In embodiments of the present disclosure, in the case of the previously successful logical channel identifier when reconfiguring the first UE by the second UE, the successful logical channel identifier may be reallocated. For example, if the second UE has transmitted the reconfiguration message to the first UE and the reconfiguration is successful, and the LCID 8 and the corresponding RLC mode of AM (i.e., the RLC mode thereof is the same as the currently configured RLC mode of the first UE) are used in the case of successful reconfiguration, then the first UE may reallocate LCID8 and transmit the RRCReconfigurationSidelink message in which the LCID8 and the corresponding RLC mode of AM are carried to the second UE, the RLC mode conflict may not occur and subsequent reconfiguration may be successful. In addition, in the case that the first UE stores a plurality of logical channel IDs with which the second UE has reconfigured the first UE successfully (when the second UE was the transmitting UE), the first UE may select the logical channel ID, corresponding to which the RLC mode is the currently configured RLC mode (e.g., AM) of the first UE.

It should be understood that the above logical channel IDs and corresponding modes are only examples and the present disclosure is not limited thereto. As described above, the method of the unicast sidelink communication of the present disclosure reduces the processing delay through reallocating the logical channel ID by the transmitting UE by itself without multiple wireless interactions with the network, in the case that the reason for the reallocation failure is the RLC mode conflict, and may adequately ensure the quality of service by reallocating the logical channel ID without adjusting the at least one other SLRB parameter.

According to embodiments of the present disclosure, the reconfiguration message is updated according to a default sidelink radio bearer (SLRB) resource, based on determining that the reason for the reconfiguration failure is that the at least one other SLRB parameter is not applicable.

According to embodiments of the present disclosure, the updating of the reconfiguration message according to the default SLRB resource may include: acquiring the default SLRB resource in different messages according to the current state of the first UE, and updating the reconfiguration message according to the acquired default SLRB resource.

According to embodiments of the present disclosure, the acquiring of the default SLRB resource in the different messages according to the current state of the first UE may include: releasing context of a current SLRB resource, acquiring the default SLRB resource in a radio resource control (RRC) reconfiguration message in response to being in an RRC connected state, acquiring the default SLRB resource in a system information block (SIB) 12 (“SIB 12”) in response to being in an RRC idle/inactive state, or acquiring the default SLRB resource in a sidelink pre-configuration information in response to being in an out-of-coverage (OOC) state. (SIB 12 is a system information block that contains information about NR sidelink communication.)

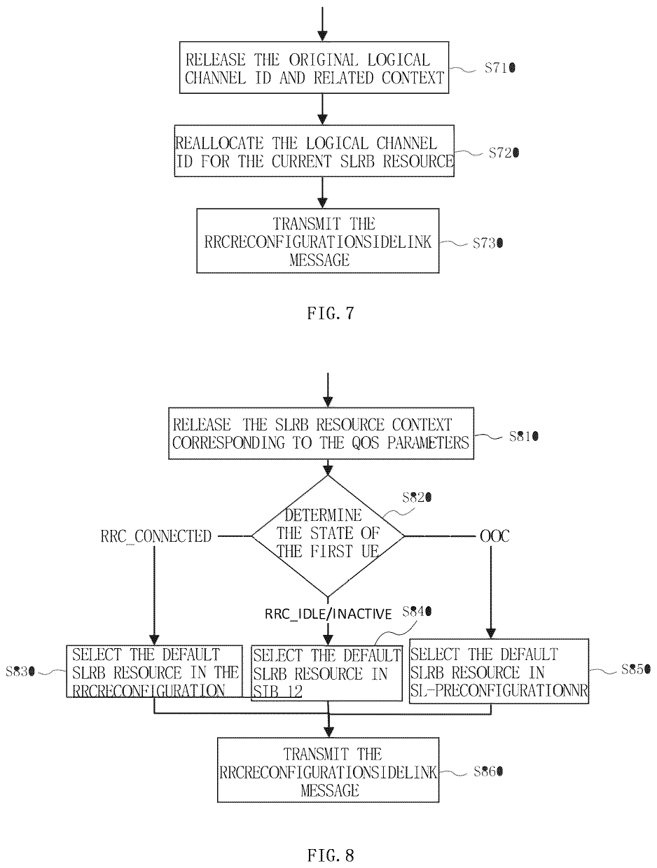

FIG. 8 illustrates a flowchart of acquisition of a default SLRB according to embodiments of the present disclosure.

If the first UE determines that the reason for the reconfiguration failure is caused by the at least one other SLRB parameter carried in the RRCReconfigurationSidelink message not being applicable, the first UE may release the current SLRB resource and acquires the default SLRB resource, and the current SLRB resource of the first UE may be the SLRB resource corresponding to the QOS parameters. Referring to FIG. 8, in operation S810, the first UE releases the SLRB resource context corresponding to the QoS parameters. Next, in operation S820, the first UE determines its current state. If the first UE is in the RRC_CONNECTED state, in operation S830, the first UE selects the default SLRB resource in the RRCReconfiguration message. If the first UE is in the RRC_IDLE/INACTIVE state, in operation S840, the first UE selects the default SLRB resource in SIB12. If the first UE is in the OOC state, in operation S850, the first UE selects the default SLRB resource in SL-PreconfigurationNR.

In embodiments of the present disclosure, if the UE is in the RRC CONNECTED state, it means that the first UE has successfully accessed the network and is in normal communication with the base station. In this case, the first UE looks up and selects the default SLRB resource in the RRCReconfiguration message. If the first UE is in the RRC IDLE/INACTIVE state, the first UE is in the idle or inactive state in which data cannot be transmitted, and in these states, the first UE will periodically listen to broadcast messages to obtain system information. At this time, the first UE may look up and select the default SLRB resource in the SIB12. The SIB 12 usually contains configuration information related to the sidelink communication that may help the first UE to obtain the resources required for the sidelink communication without restoring the RRC connection. If the first UE is in the OOC state, that is, the first UE is completely outside of the network coverage area and is unable to receive signals from the base station, the first UE will rely on the sidelink pre-configuration information for the sidelink communication. In this case, the UE may look up and select the default SLRB resource in the sidelink pre-configuration (SL-PreconfigurationNR) information. The SL-PreconfigurationNR contains pre-configured sidelink communication parameters and resource information available to the UE when it is in the OOC state. The first UE, after acquiring the default SLRB resource, may release the current logical channel ID and may reselect the logical channel ID corresponding to the logical channel configured with the same RLC mode according to the RLC mode in the parameters corresponding to the default SLRB resource. Here, the RLC mode corresponding to the reselected logical channel ID should be consistent with the RLC mode in the parameters corresponding to the default SLRB resource, and the method of reselecting the logical channel ID may refer to the method of reallocating the logical channel ID in the scenario of the RLC mode conflict described above.

After acquiring the default SLRB resource, the first UE also reconfigures the second UE. The first UE may update the RRCReconfigurationSidelink message according to the parameters corresponding to the default SLRB resource, and in operation S860, the first UE transmits the updated RRCReconfigurationSidelink message to the first UE, and specifically, the first UE may transmit the RRCReconfigurationSidelink message including the parameters corresponding to the default SLRB resource to the second UE. In addition, the updated RRCReconfigurationSidelink message may further include the reselected logical channel ID. The second UE which receives the updated RRCReconfigurationSidelink message may no longer experience the anomaly situation that the at least one other SLRB parameter is not applicable and may be successfully reconfigured.

In embodiments of the present disclosure, after the first UE receives the RRCReconfigurationFailureSidelink message, the upper layer configuration may initiate the optimization processing for the reconfiguration failure. In this case, if the RRCReconfigurationFailureSidelink message does not include the extended field of sl-RLC-Mode-Conflict, the first UE may update the reconfiguration message according to the default SLRB resource. In other words, in this case, without distinguishing whether or not the reason for the reconfiguration failure is the RLC mode conflict, it is handled with reference to the abnormal situation of “the at least one other SLRB parameter not being applicable” as described above, and the first UE will acquire the default SLRB resource and reconfigure the second UE.

As described above, the method of the unicast sidelink communication of the present disclosure acquires the default SLRB parameter configuration when the reason for the reconfiguration failure is that the at least one other SLRB parameter is not applicable, and the default SLRB resource corresponding to the RRC state is fully utilized, which avoids that the sidelink service may not be carried out normally in the abnormal situation, so as to improve the security and reliability of the communication.

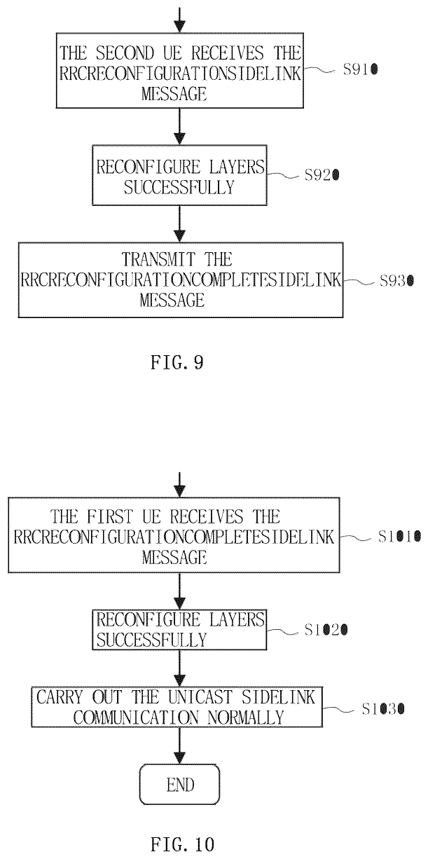

FIG. 9 illustrates a flowchart of a successful reconfiguration for a second UE according to embodiments of the present disclosure. Referring to FIG. 9, in operation S910, the second UE receives the RRCReconfigurationSidelink message, which may be the updated RRCReconfigurationSidelink message transmitted by the first UE. After receiving the RRCReconfigurationSidelink message, in operation S920, the second UE reconfigures layers successfully. And in the case of successful reconfiguration, in operation S930, the second UE transmits the RRCReconfigurationCompleteSidelink message to the first UE.

FIG. 10 illustrates a flowchart of a successful reconfiguration for a first UE according to embodiments of the present disclosure. Referring to FIG. 10, in operation S1010, the first UE receives the RRCReconfigurationCompleteSidelink message transmitted by the second UE. After receiving the RRCReconfigurationCompleteSidelink message transmitted by the second UE, in operation S1020, the first UE configures the layers successfully. In the case of successful configuration, the first UE may normally carry out the unicast sidelink communication in operation S1030.

As described above, the method of the unicast sidelink communication of the present disclosure adopts different treatments, according to whether the reason for the reconfiguration failure is the RLC mode conflict. In the abnormal situation in which the reason for the sidelink reconfiguration failure is the RLC mode conflict, the method may reallocate the logical channel ID without adjusting other SLRB parameters, which may adequately ensure the quality of service and may achieve the same communication effect as in the normal situation. In the case that the reason for the sidelink reconfiguration failure is not the RLC mode conflict (i.e., the reason for the reallocation failure is that the at least one other SLRB parameter is not applicable), the method may adopt the default SLRB parameter configuration, which may ensure the reliability and continuity of the communication in the abnormal situation, although it may have an impact on the quality of service to a certain extent. In addition, the manner of selecting the default SLRB resource by the transmitting UE (i.e., the first UE) may reduce the conflict of SLRB resources, and the selected default SLRB resource may be more compatible with the capability (e.g., the UE capability reported by the UE in the in-network mode) of the transmitting UE. Thus, embodiments of the method of the unicast sidelink communication of the present disclosure may optimally deal with the reconfiguration failure according to whether the reason for the reconfiguration failure is the RLC mode conflict, which may ensure the quality of service as well as the robustness and security of the communication to the extreme.

In addition, embodiments of the method of the unicast sidelink communication of the present disclosure may not limit the state of the UE, but may be applied to the in-coverage (IC) and out-of-coverage (OOC) states of the UE, and the method may achieve the high reliability and low latency when applied to a specific field (e.g., the vehicle to everything (V2X)).

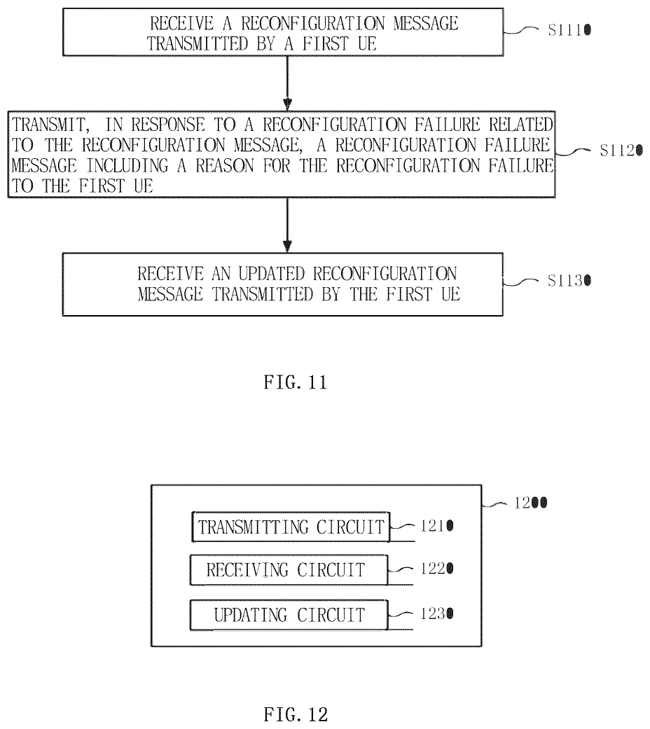

FIG. 11 illustrates a flowchart of a method of unicast sidelink communication applied to a second UE according to embodiments of the present disclosure.

In operation S1110, a reconfiguration message transmitted by a first UE is received.

In operation S1120, in response to a reconfiguration failure related to the reconfiguration message, a reconfiguration failure message including a reason for the reconfiguration failure is transmitted to the first UE.

According to embodiments of the present disclosure, the transmitting of the reconfiguration failure message including the reason for the reconfiguration failure to the first UE may include: using the received reconfiguration message to set an extended field included in the reconfiguration failure message according to whether an RLC mode conflict for the same logical channel occurs, and transmitting the reconfiguration failure message including the reason for the reconfiguration failure indicated by the extended field to the first UE.

In operation S1130, an updated reconfiguration message transmitted by the first UE is received, wherein the updated reconfiguration message is the reconfiguration message updated by the first UE based on the reason for the reconfiguration failure.

According to embodiments of the present disclosure, a logical channel identifier is reallocated by the first UE based on determining that the reason for the reconfiguration failure is the RLC mode conflict and the reconfiguration message is updated according to the reallocated logical channel identifier, or the reconfiguration message is updated by the first UE according to a default sidelink radio bearer (SLRB) resource, based on determining that the reason for the reconfiguration failure is that the at least one other SLRB parameter is not applicable.

According to embodiments of the present disclosure, the logical channel identifier is a logical channel identifier reallocated by the first UE after releasing an original logical channel identifier and related context, and the reallocated logical channel identifier is different from the original logical channel identifier.

According to embodiments of the present disclosure, the logical channel identifier is an unused logical channel identifier reallocated by the first UE, or the logical channel identifier, in a case of the presence of a previously successful logical channel identifier when reconfiguring the first UE by the second UE, the successful logical channel identifier is reallocated by the first UE.

According to embodiments of the present disclosure, the default SLRB resource is acquired by the first UE in different messages according to its current state, and the reconfiguration message is updated according to the acquired default SLRB resource.

According to embodiments of the present disclosure, the default SLRB resource is acquired in a radio resource control (RRC) reconfiguration message in response to the first UE being in an RRC connected state, acquired in a system information block (SIB) 12 in response to the first UE being in an RRC idle/inactive state, or acquired in a sidelink pre-configuration information in response to the first UE being in an out-of-coverage (OOC) state, by the first UE after releasing context of a current SLRB resource.

FIG. 12 illustrates a block diagram of a first UE according to embodiments of the present disclosure.

Referring to FIG. 12, the first UE 1200 includes a transmitting circuit 1210, a receiving circuit 1220, and an updating circuit 1230, wherein the transmitting circuit 1210 may transmit a reconfiguration message to a second UE and transmit an updated reconfiguration message to the second UE, the receiving circuit 1220 may receive a reconfiguration failure message indicative of a reconfiguration failure related to the reconfiguration message, and including a reason for the reconfiguration failure, transmitted by the second UE in response to the reconfiguration failure, and the updating circuit 1230 may update the reconfiguration message to generate the updated reconfiguration message, based on the reason for the reconfiguration failure.

According to embodiments of the present disclosure, the reason for the reconfiguration failure is indicated by an extended field included in the reconfiguration failure message, wherein the extended field is set by the second UE using the received reconfiguration message according to whether an RLC mode conflict for the same logical channel occurs.

According to embodiments of the present disclosure, the updating circuit 1230 may reallocate a logical channel identifier based on determining that the reason for the reconfiguration failure is the RLC mode conflict, and update the reconfiguration message according to the reallocated logical channel identifier, or update the reconfiguration message according to a default SLRB resource, based on determining that the reason for the reconfiguration failure is that the at least one other sidelink radio bearer (SLRB) parameter is not applicable.

According to embodiments of the present disclosure, the first UE may further include an optimization initialization circuit (not shown), wherein the optimization initialization circuit may check, after receiving the reconfiguration failure message, whether optimization processing for the reconfiguration failure is initiated via an upper layer configuration, and determine, in the case that the optimization processing for the reconfiguration failure is initiated, whether the reason for the reconfiguration failure is the RLC mode conflict.

According to embodiments of the present disclosure, the updating circuit 1230 may release an original logical channel identifier and related context, and reallocate a logical channel identifier that is different from the original logical channel identifier.

According to embodiments of the present disclosure, the updating circuit 1230 may reallocate an unused logical channel identifier, or reallocate, in the case of a previously successful logical channel identifier when reconfiguring the first UE by the second UE, the successful logical channel identifier.

According to embodiments of the present disclosure, the updating circuit 1230 may acquire the default SLRB resource in different messages according to the current state of the first UE, and update the reconfiguration message according to the acquired default SLRB resource.

According to embodiments of the present disclosure, the updating circuit 1230 may release context of a current SLRB resource, and acquire the default SLRB resource in a radio resource control (RRC) reconfiguration message in response to being in an RRC connected state, acquire the default SLRB resource in a system information block (SIB) 12 in response to being in an RRC idle/inactive state, or acquire the default SLRB resource in a sidelink pre-configuration information in response to being in an out-of-coverage (OOC) state.

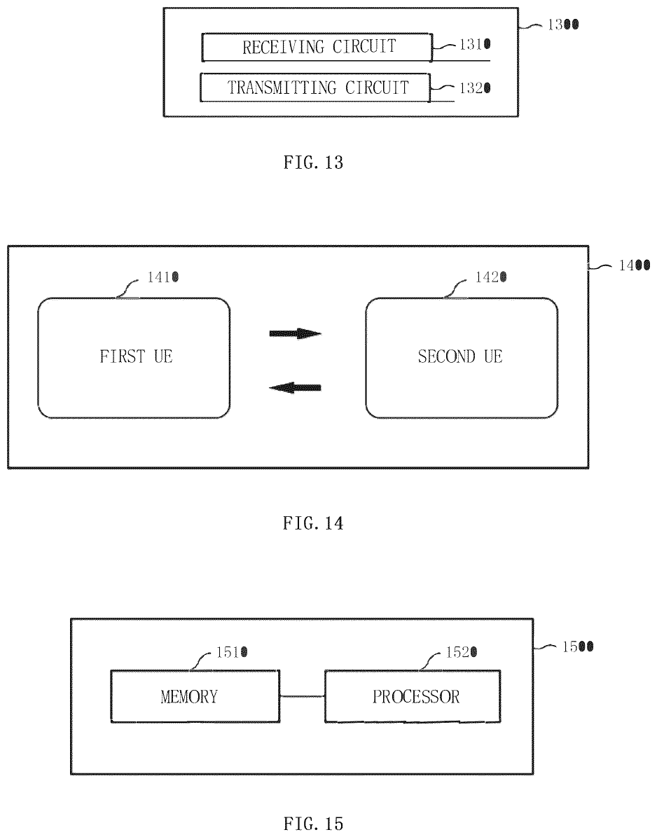

FIG. 13 illustrates a block diagram of a second UE according to embodiments of the present disclosure.

Referring to FIG. 13, the second UE 1300 includes a receiving circuit 1310 and a transmitting circuit 1320, wherein the receiving circuit 1310 may receive a reconfiguration message transmitted by a first UE and receive an updated reconfiguration message transmitted by the first UE, and the transmitting circuit 1320 may transmit, in response to a reconfiguration failure related to the reconfiguration message, a reconfiguration failure message including a reason for the reconfiguration failure to the first UE, wherein the updated reconfiguration message is the reconfiguration message updated by the first UE based on the reason for the reconfiguration failure.

According to embodiments of the present disclosure, the transmitting circuit 1320 may use the received reconfiguration message to set an extended field included in the reconfiguration failure message according to whether an RLC mode conflict for the same logical channel occurs, and transmit the reconfiguration failure message including the reason for the reconfiguration failure indicated by the extended field to the first UE.

FIG. 14 illustrates a system of unicast sidelink communication according to embodiments of the present disclosure.

Referring to FIG. 14, the system 1400 of the unicast sidelink communication includes a first UE 1410 and a second UE 1420. The first UE 1410 may transmit a reconfiguration message to the second UE 1420, receive a reconfiguration failure message indicative of a reconfiguration failure related to the reconfiguration message, transmitted by the second UE in response to the reconfiguration failure and including a reason for the reconfiguration failure transmitted by the second UE 1420 in response to the reconfiguration failure, update the reconfiguration message based on the reason for the reconfiguration failure, and transmit the updated reconfiguration message to the second UE 1420. The second UE 1420 may receive the reconfiguration message transmitted by the first UE 1410, transmit, in response to the reconfiguration failure related to the reconfiguration message, the reconfiguration failure message including the reason for the reconfiguration failure to the first UE 1410, and receive the updated reconfiguration message transmitted by the first UE 1410.

Furthermore, any relevant details involved in the operations performed by the first UE 1410 and the second UE 1420 in FIG. 14 may refer to the corresponding descriptions with respect to FIGS. 12 and 13, and will not be repeated herein.

FIG. 15 illustrates a block diagram of an electronic apparatus according to embodiments of the present disclosure.

An electronic apparatus 1500 may be the first UE (Tx UE) and the second UE (Rx UE) of the embodiments of the disclosure. Referring to FIG. 15, the electronic apparatus 1500 may include at least one memory 1510 and at least one processor 1520, the at least one memory may store a set of computer executable instructions therein, and the set of computer executable instructions when executed by the at least one processor implement the method of the unicast sidelink communication according to embodiments of the disclosure.

Here, the electronic apparatus may not be a single electronic apparatus, but may also be any collection of devices or circuits capable of executing the instructions (or instruction set) individually or in combination. The electronic apparatus may also be part of an integrated control system or system manager, or may be configured to be an electronic apparatus connecting local or remote (e.g., via wireless transmission) with an interface.

In an electronic apparatus, the processor may include a central processing unit (CPU), a graphic processing unit (GPU), a programmable logic device, a dedicated processor system, a microcontroller, or a microprocessor. As an example and not a limitation, a processor may also include an analog processor, a digital processor, a microprocessor, a multi-core processor, a processor array, a network processor, and the like.

The processor may run instructions or code stored in the memory, wherein the memory may also store data. The instructions and data may also be transmitted, and received, over a network via a network interface device, wherein the network interface device may employ any known transmission protocol.

The memory may be integrated with the processor, for example, by arranging RAM or flash memory within an integrated circuit microprocessor. In addition, the memory may comprise a separate device, such as an external disk drive, a storage array, or any other storage device that may be used by the database system. The memory and the processor may be operationally coupled or may communicate with each other, for example, via I/O ports, network connections, etc., so that the processor may read the files stored in the memory.

In addition, the electronic apparatus may also include a video display (e.g., LCD) and a user interaction interface (such as a keyboard, mouse, touch input device, etc.). All components of the electronic apparatus may be connected to each other via a bus and/or network.

In addition, the electronic apparatus may be an apparatus with the wired and wireless communication capabilities and may also include a transceiver to enable transmitting and receiving of communication signals.

According to embodiments of the disclosure, a computer-readable storage medium may also be provided, wherein a computer program is stored thereon, the program when executed may implement the method of the unicast sidelink communication according to the present disclosure. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), solid state drive (SSD), card-based memory (such as, multimedia cards, Secure Digital (SD) cards or Extreme Digital (XD) cards), magnetic tapes, floppy disks, magneto-optical data storage devices, optical data storage devices, hard disks, solid state disks, and any other device, where the other device is configured to store the computer programs and any associated data, data files, and data structures in a non-transitory manner and to provide the computer programs and any associated data, data files, and data structures to a processor or computer, so that the processor or computer may execute the computer program. The computer program in the computer readable storage medium may run in an environment deployed in a computer device such as a terminal, client, host, agent, server, etc., and furthermore, in one example, the computer program and any associated data, data files and data structures are distributed on a networked computer system such that the computer program and any associated data, data files and data structures are stored, accessed, and executed in a distributed manner by one or more processors or computers.

The method of the unicast sidelink communication and the device thereof as described above optimally deal with the reconfiguration failure according to whether the reason for the reconfiguration failure is the RLC mode conflict, in the abnormal situation in which the reason for the sidelink reconfiguration failure is the RLC mode conflict, the logical channel ID is reallocated without adjusting other SLRB parameters, which may adequately ensure the quality of service and may achieve the same communication effect as in the normal situation. In the case that the reason for the sidelink reconfiguration failure is not the RLC mode conflict (i.e., the reason for the reallocation failure is that the at least one other SLRB parameter is not applicable), the default SLRB parameter configuration may be adopted, which may ensure the reliability and continuity of the communication in the abnormal situation, despite of the impact on the quality of service to a certain extent. In addition, the manner of selecting the default SLRB resource by the transmitting UE may reduce the conflict of SLRB resources, and the selected default SLRB resource may be more compatible with the capability of the transmitting UE. The method of the unicast sidelink communication and the device thereof according to the present disclosure may provide more reliable quality of service, more robust communication capabilities, and more secure performance.

Other embodiments of the disclosure will readily come to the mind of those skilled in the art upon consideration of the specification and practice of the inventive concepts disclosed herein. This application is intended to cover any variations, uses, or adaptations of the present disclosure that follow the general principles of the disclosure and include commonly known or customary technical means in the art that are not disclosed herein. Embodiments provided in the specification are merely examples, and the scope and spirit of the disclosure is indicated by the following claims.

It is to be understood that the disclosure is not limited to the precise structure already described above and illustrated in the accompanying drawings, and that various modifications and changes may be made without departing from its scope. The scope of the present disclosure is limited only by the appended claims.

1. A method of unicast sidelink communication, performed by a first user equipment (UE), the method comprising:
transmitting a reconfiguration message to a second UE;
receiving a reconfiguration failure message indicative of a reconfiguration failure related to the reconfiguration message, transmitted by the second UE in response to the reconfiguration failure and including a reason for the reconfiguration failure;
updating the reconfiguration message based on the reason for the reconfiguration failure; and
transmitting the updated reconfiguration message to the second UE.

2. The method of claim 1, wherein the reason for the reconfiguration failure is indicated by an extended field included in the reconfiguration failure message, wherein the extended field is set by the second UE using the received reconfiguration message according to whether a radio link control (RLC) mode conflict for the same logical channel occurs.

3. The method of claim 1, wherein the updating of the reconfiguration message based on the reason for the reconfiguration failure comprises:
reallocating a logical channel identifier based on determining that the reason for the reconfiguration failure is the RLC mode conflict, and updating the reconfiguration message according to the reallocated logical channel identifier; or
updating the reconfiguration message according to a default sidelink radio bearer (SLRB) resource, based on determining that the reason for the reconfiguration failure is that at least one other SLRB parameter is not applicable.

4. The method of claim 3, wherein the method further comprises:
checking, after receiving the reconfiguration failure message, whether optimization processing for the reconfiguration failure is initiated via an upper layer configuration, and if so, determining whether the reason for the reconfiguration failure is the RLC mode conflict.

5. The method of claim 3, wherein the reallocating of the logical channel identifier comprises:
releasing an original logical channel identifier and related context; and
reallocating a logical channel identifier that is different from the original logical channel identifier.

6. The method of claim 5, wherein the reallocating of the logical channel identifier that is different from the original logical channel identifier comprises:
reallocating an unused logical channel identifier; or
reallocating, in a case of a previously successful logical channel identifier when reconfiguring the first UE by the second UE, the successful logical channel identifier.

7. The method of claim 3, wherein the updating of the reconfiguration message according to the default SLRB resource comprises:
acquiring the default SLRB resource in different messages according to a current state of the first UE; and
updating the reconfiguration message according to the acquired default SLRB resource.

8. The method of claim 7, wherein the acquiring of the default SLRB resource in the different messages according to the current state of the first UE comprises:
releasing context of a current SLRB resource; and
acquiring the default SLRB resource in a radio resource control (RRC) reconfiguration message in response to being in an RRC connected state, acquiring the default SLRB resource in a system information block (SIB) 12 in response to being in an RRC idle/inactive state, or acquiring the default SLRB resource in a sidelink pre-configuration information in response to being in an out-of-coverage (OOC) state.

9. A method of unicast sidelink communication, performed by a second user equipment (UE), the method comprising:
receiving a reconfiguration message transmitted by a first UE;
transmitting, in response to a reconfiguration failure related to the reconfiguration message, a reconfiguration failure message including a reason for the reconfiguration failure to the first UE; and
receiving an updated reconfiguration message transmitted by the first UE,
wherein the updated reconfiguration message is the reconfiguration message updated by the first UE based on the reason for the reconfiguration failure.

10. The method of claim 9, wherein the transmitting of the reconfiguration failure message including the reason for the reconfiguration failure to the first UE comprises:
using the received reconfiguration message to set an extended field included in the reconfiguration failure message according to whether a radio link control (RLC) mode conflict for the same logical channel occurs; and
transmitting the reconfiguration failure message comprising the reason for the reconfiguration failure indicated by the extended field to the first UE.

11. The method of claim 9, wherein a logical channel identifier is reallocated by the first UE based on determining that the reason for the reconfiguration failure is the RLC mode conflict and the reconfiguration message is updated according to the reallocated logical channel identifier; or
the reconfiguration message is updated by the first UE according to a default sidelink radio bearer (SLRB) resource, based on determining that the reason for the reconfiguration failure is that the at least one other SLRB parameter is not applicable.

12. The method of claim 11, wherein the logical channel identifier is a logical channel identifier reallocated by the first UE after releasing an original logical channel identifier and related context, which is different from the original logical channel identifier.

13. The method of claim 12, wherein the logical channel identifier is an unused logical channel identifier reallocated by the first UE, or
the logical channel identifier, in a case of a previously successful logical channel identifier when reconfiguring the first UE by the second UE, is the successful logical channel identifier reallocated by the first UE.

14. The method of claim 11, wherein the default SLRB resource is acquired by the first UE in different messages according to a current state of the first UE, and the reconfiguration message is updated according to the acquired default SLRB resource.

15. The method of claim 14, wherein the default SLRB resource is acquired in a radio resource control (RRC) reconfiguration message in response to the first UE being in an RRC connected state, acquired in a system information block (SIB) 12 in response to the first UE being in an RRC idle/inactive state, or acquired in a sidelink pre-configuration information in response to the first UE being in an out-of-coverage (OOC) state, by the first UE after releasing context of a current SLRB resource.

16. A first user equipment (UE), comprising:
a transmitting circuit configured to transmit a reconfiguration message to a second UE and to transmit an updated reconfiguration message to the second UE;
a receiving circuit configured to receive a reconfiguration failure message indicative of a reconfiguration failure related to the reconfiguration message, and including a reason for the reconfiguration failure, transmitted by the second UE in response to the reconfiguration failure; and
an updating circuit configured to update the reconfiguration message to generate the updated reconfiguration message, based on the reason for the reconfiguration failure.

17. The first UE of claim 16, wherein the reason for the reconfiguration failure is indicated by an extended field included in the reconfiguration failure message, wherein the extended field is set by the second UE using the received reconfiguration message according to whether a radio link control (RLC) mode conflict for the same logical channel occurs.

18. The first UE of claim 16, wherein the updating circuit is configured to:
reallocate a logical channel identifier based on determining that the reason for the reconfiguration failure is the RLC mode conflict, and update the reconfiguration message according to the reallocated logical channel identifier; or
update the reconfiguration message according to a default SLRB resource, based on determining that the reason for the reconfiguration failure is that at least one other sidelink radio bearer (SLRB) parameter is not applicable.

19. The first UE of claim 18, wherein the first UE further comprises an optimization initialization circuit configured to:
check, after receiving the reconfiguration failure message, whether optimization processing for the reconfiguration failure is initiated via an upper layer configuration; and
determine, in the case that the optimization processing for the reconfiguration failure is initiated, whether the reason for the reconfiguration failure is the RLC mode conflict.

20. The first UE of claim 18, wherein the updating circuit is configured to:
release an original logical channel identifier and related context, and
reallocate a logical channel identifier that is different from the original logical channel identifier.

21-32. (canceled)
